(19) United States
(12) Patent Application Publication
(10) Pub. No.: US 2017/0276367 A1
(43) Pub. Date: Sep. 28, 2017

(54) FUEL SUPPLY SYSTEM FOR AN ENGINE

(71) Applicant: Solar Turbines Incorporated, San Diego, CA (US)

(72) Inventor: Anthony Paul Batakis, San Diego, CA (US)

(73) Assignee: Solar Turbines Incorporated, San Diego, CA (US)

(21) Appl. No.: 15/079,514

(22) Filed: Mar. 24, 2016

(51) Int. Cl. F23R 3/34; F02C 9/26

(52) U.S. Cl. CPC F23R 3/34; F02C 9/26; F05D 2220/32; F05D 2240/35

(57) ABSTRACT

A fuel supply system for a combustion chamber having at least two combustion zones in which each combustion zone is arranged at a height different from the other includes a pair of fuel injectors that are configured to supply fuel to respective ones of the combustion zones. The pair of fuel injectors are disposed at different heights corresponding to the different heights of the combustion zones, each of the heights being taken in reference with one of a lower one of the fuel injectors and a horizontal midplane of the combustion chamber. The system also includes a flow control device in fluid communication with at least the lower one of the fuel injectors. The flow control device is configured to selectively regulate a supply of fuel to the lower fuel injector based, at least in part, on an amount of fuel supplied to an upper one of the fuel injectors.

### TECHNICAL FIELD

The present disclosure relates to a fuel supply system. More particularly, the present disclosure relates to a fuel supply system for an engine having fuel injectors in which the fuel injectors are being arranged at different heights relative to one another.

### BACKGROUND

It is well known in the art to locate a pair of fuel injectors at different positions corresponding to a positioning of one or more combustion zones in an engine. While the flexibility to locate the fuel injectors at different positions may allow manufacturers to accomplish system design with ease, operation of the fuel injectors may be affected by way of a non-uniform fuel supply to each injector in a group of fuel injectors, for example, when a pair of fuel injectors are provided on an engine in which each of the injectors is located at a different height relative to one another. In many cases, it has been observed that the non-uniform flow of fuel may be occurring, at least in part, due to the effect of gravity acting on one or more fuel injectors that are placed substantially lower than a remainder of the fuel injectors present on the engine.

U.S. Pat. No. 6,314,998 (hereinafter referred to as “the '998 patent”) discloses a fuel control system for distributing metered quantities of fuel to each fuel manifold from a plurality of manifolds associated with the engine. However, many previously known systems including, but not limited to, the fuel control system of the '998 patent may exhibit added design complexity besides being ineffective in compensating for the effect of gravity on the distribution of fuel to each of the injectors.

Hence, there is a need for a fuel supply system that compensates for the effect of gravity in distributing an amount of fuel to each injector and therefore, effective in accomplishing a uniform fuel supply to each injector from the group of fuel injectors present on an engine.

### SUMMARY OF THE DISCLOSURE

In an aspect of this disclosure, a fuel supply system is provided for an engine having at least one combustion chamber in which the combustion chamber includes at least two combustion zones, the combustion zones being arranged at different heights from one another.

The fuel supply system includes at least a pair of fuel injectors corresponding to the at least two combustion zones such that at least one injector is configured to provide a supply of fuel to one combustion zone from the at least two combustion zones. The pair of fuel injectors are disposed at different heights corresponding to the different heights of the combustion chambers, each of the heights being taken in reference with one of: a lower one of the fuel injectors and a horizontal midplane of the engine.

The fuel supply system also includes a flow control device that is located upstream of the pair of fuel injectors and disposed in fluid communication with at least the lower one of the fuel injectors. The flow control device is configured to selectively regulate a supply of fuel to the lower fuel injector based, at least in part, on an amount of fuel supplied to an upper one of the fuel injectors.

In another aspect, embodiments of the present disclosure are also directed to an engine using the fuel supply system of the present disclosure.

In yet another aspect of this disclosure, a method is provided for supplying fuel to two or more injectors associated with an engine, the injectors being positioned at heights different from one another. The method includes providing a supply of fuel based on load and speed conditions of the engine; and selectively regulating a supply of fuel to a lower one of the fuel injectors based, at least in part, on an amount of fuel supplied to an upper one of the fuel injectors.

Other features and aspects of this disclosure will be apparent from the following description and the accompanying drawings.

### BRIEF DESCRIPTION OF THE DRAWINGS

FIG. 1 is a perspective view of an exemplary gas turbine engine, in accordance with an embodiment of the present disclosure;

FIG. 2 is a breakaway perspective view of the exemplary gas turbine engine showing a combustor section, in accordance with an embodiment of the present disclosure;

FIG. 3 is a section view taken along section plane AA′ of the combustor section from FIG. 2;

FIG. 4 is a schematic of a fuel supply system showing a flow control device operably communicating with a pair of fuel injectors taken from the combustor section of FIG. 3, in accordance with an embodiment of the present disclosure;

FIG. 5 is a schematic of the flow control device, in accordance with another embodiment of the present disclosure; and

FIG. 6 is a flowchart depicting a method for supplying fuel to two or more injectors associated with an engine, the injectors being positioned at heights different from one another.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

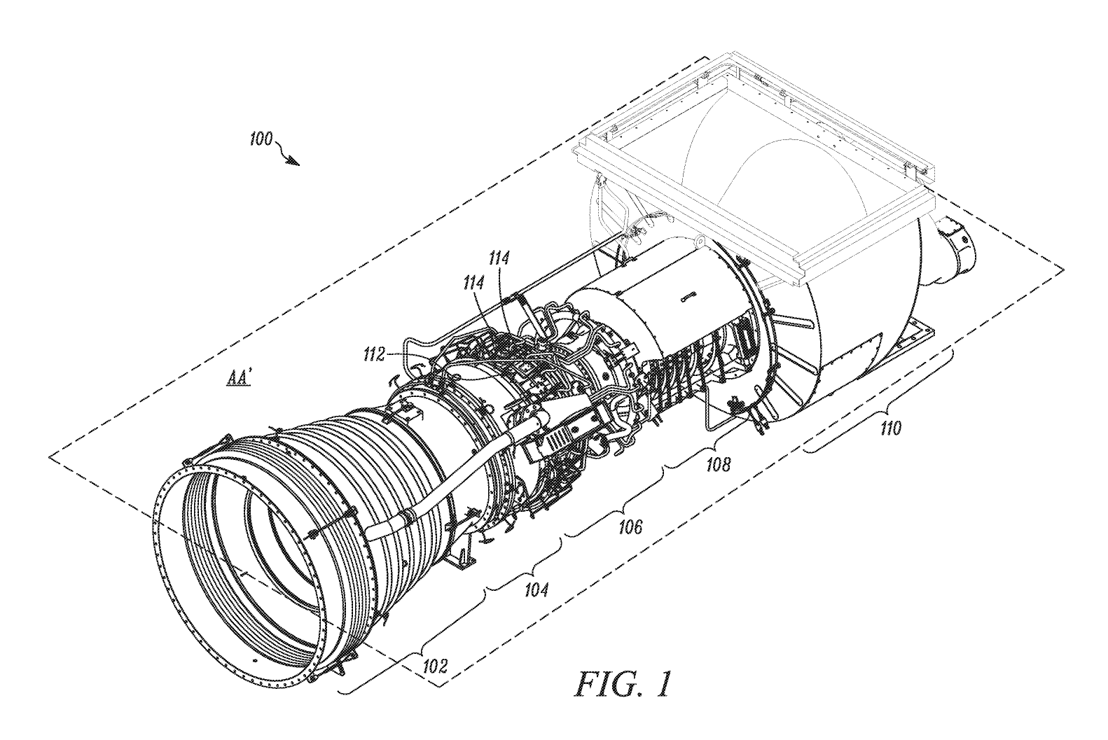

The present disclosure relates to a fuel supply system for an engine. Although, the present disclosure focuses on gas turbine engines, structures, processes, and methods disclosed herein may be similarly applicable for use in other types of engines such as internal combustion engines. FIG. 1 shows a perspective view of an exemplary gas turbine engine 100. The gas turbine engine 100 may be of any type. In one embodiment, the gas turbine engine 100 may be used to drive a generator for power generation, or other mechanical assemblies such as a compressor. In other embodiments, the gas turbine engine 100 may be employed in mobile machines such as but not limited to earth moving machines, passenger vehicles, marine vessels, or any other mobile machine known in the art.

The gas turbine engine 100 may include an inlet section 102, a compressor section 104, a combustor section 106, a turbine section 108, and an exhaust section 110. The compressor section 104 may include a series of compressor blades (not shown) that are rotatable to compress air. As the compressor blades are rotated, the compressor blades may draw air into the gas turbine engine 100 via the inlet section 102 for pressurizing the drawn air. The pressurized air may then be directed towards the combustor section 106. The combustor section 106 may mix a liquid and/or gaseous fuel with the compressed air from the compressor section 104 and combust the mixture to produce a mechanical work output that can be used to drive the turbine section 108. Products of combustion may then exit the turbine section 108 via the exhaust section 110 of the gas turbine engine 110.

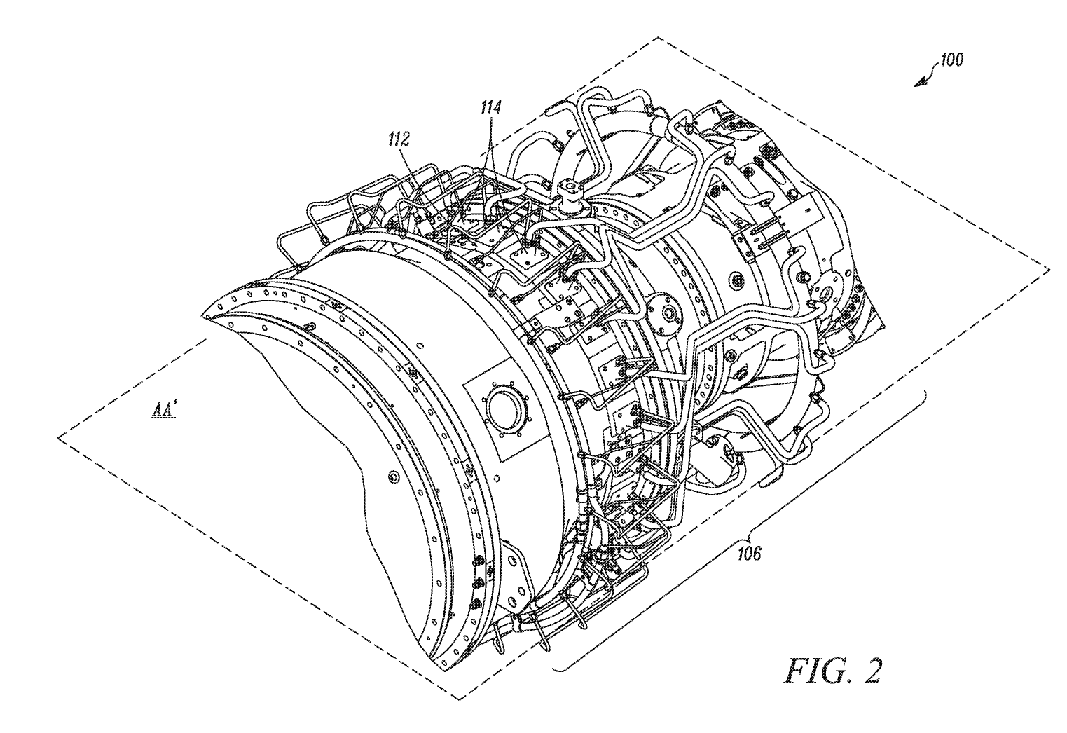

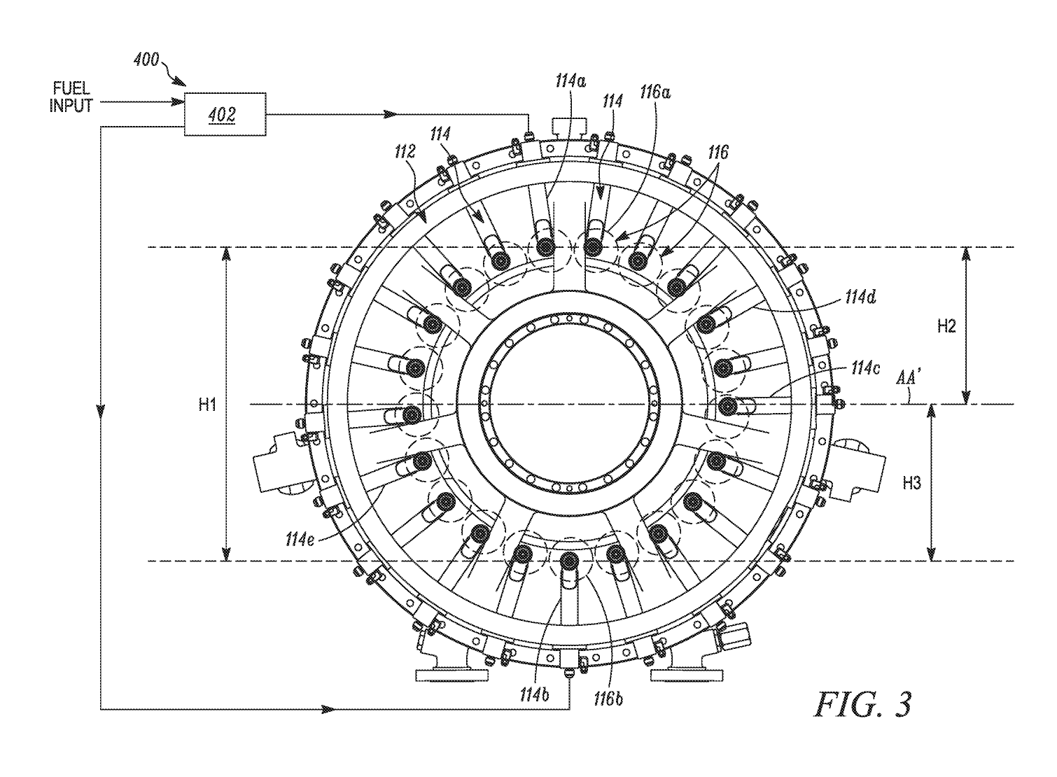

Further, as shown in FIG. 1, the combustor section 106 may include a combustion chamber 112, and two or more fuel injectors 114 associated with the combustion chamber 112. In an embodiment as shown in FIGS. 2-3, the fuel injectors 114 may be annularly arranged about the combustion chamber 112 and hence, configured to correspond with different combustion zones 116 of the combustion chamber 112. As shown in the illustrated embodiment of FIG. 3, the combustion chamber 112 defines multiple combustion zones 116 in which each of the combustion zones 116 is arranged at heights different from one another. For example, the combustion zone 116a is positioned at a height H1 with respect to the combustion zone 116b.

Further, in the illustrated embodiment of FIG. 3, a single annular combustion chamber 112 is shown in which multiple combustion zones 116 are disposed in communication with each other. However, in other embodiments, the gas turbine engine 100 may be configured to alternatively include multiple combustion chambers, each of which may be configured to define a combustion zone therein such that the combustion zones from each of the combustors are distinctly located from one another. Therefore, it should be noted that a configuration of combustion zones, whether contiguous or independent of each other, in the gas turbine engine 100 is merely exemplary in nature and hence, non-limiting of this disclosure. Embodiments of this disclosure may be similarly applied to any configuration of combustion zones defined by suitable structures known to persons skilled in the art without deviating from the spirit of the present disclosure.

Referring to FIG. 3, as each combustion zone 116 of the annular combustion chamber 112 may be positioned at different heights relative to one another, each fuel injector 114 is also subsequently positioned to communicate fuel with a respective one of the combustion zones 116 in the annular combustion chamber 112. Moreover, it may be noted that although one fuel injector 114 is shown to correspond with each combustion zone 116 in the illustrated embodiment of FIG. 3, a number of fuel injectors 114 disposed in communication with each combustion zone 116 is exemplary and non-limiting of this disclosure. Any number of injectors 114 can be used with each of the given combustion zones 116 in the combustion chamber 112. For example, two fuel injectors 114 may be positioned to communicate fuel with a single combustion zone 116 of the combustion chamber 112.

With continued reference to the illustrated embodiment of FIG. 3, as each fuel injector 114 is configured to correspond with one combustion chamber 116, each fuel injector 114 may be disposed at a height different from a remainder of the fuel injectors 114 present on the combustion chamber 112. In the example of FIG. 3, the injector 114a is shown positioned at a height H1 relative to the injector 114b.

In this specification, reference to the injector 114a may be made as an “upper one of the injectors” or “upper injector” while reference to the injector 114b may be made as a “lower one of the injectors” or a “lower injector” and such references will be similarly accompanied by respective ones of their identical numerals 114a and 114b. In certain embodiments of this disclosure, such references can be construed as being reflective of the heights of the upper and lower injectors 114a and 114b being taken in reference with a datum that corresponds with the lower injector 114b itself. For example, as shown in FIG. 3, the heights of the upper and lower injectors 114a, 114b are taken with respect to a position of the lower injector 114b itself and hence, the difference in height between the upper and lower injectors 114a and 114b is being denoted by a single alpha-numeral “H1”.

In other embodiments of this disclosure, such references can alternatively be regarded as being reflective of the heights of the upper and lower injectors 114a and 114b taken with respect to a datum that corresponds with a horizontal midplane AA′ of the gas turbine engine 100 (shown in FIG. 1), such horizontal midplane AA′ being particularly associated with the combustor chamber 112 of the gas turbine engine 100 (shown in FIGS. 2 and 3) around which the injectors 116 may be disposed. For example, as shown in FIG. 3, the upper and lower injectors 114a and 114b are shown positioned at heights H2 and H3 relative to the injector 114c which is located substantially along the horizontal midplane AA′ of the combustion chamber 112.

In embodiments of this disclosure, the gas turbine engine includes a fuel supply system 400 having a flow control device 402 that is disposed in fluid communication with at least the lower fuel injector 114b. Additionally, as shown in the illustrated embodiment of FIG. 3, the flow control device 402 could also be disposed in communication with the upper fuel injector 114a. The flow control device 402 is configured to selectively regulate a supply of fuel to the lower fuel injector 114b based, at least in part, on an amount of fuel supplied to the upper fuel injector 114a.

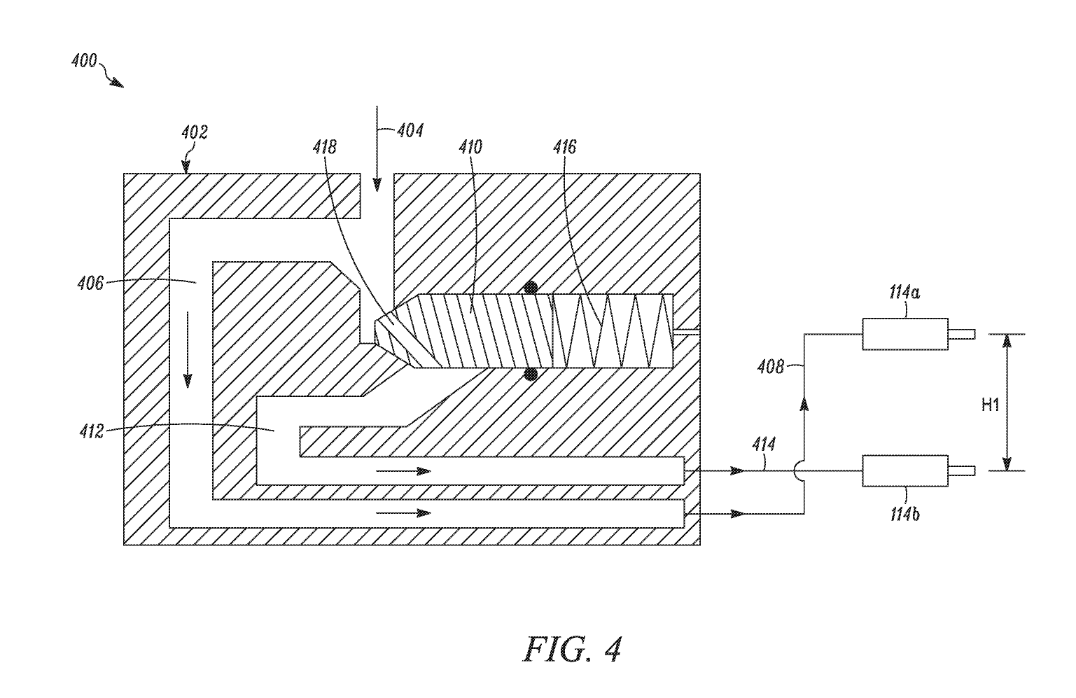

As shown in the exemplary configuration of the flow control device 402 of FIG. 4, the flow control device 402 is embodied in the form of a hydraulically operated flow control device. However in other embodiments of this disclosure, it will be appreciated the flow control device 402 may be alternatively embodied in the form of an electronically operated flow control device. Such electronically operated flow control device may be suitably provided with associated system hardware including, but not limited to, solenoid circuitry, solenoid drivers, and the like for performing functions consistent with the present disclosure.

In an exemplary configuration of the flow control device 402 as shown in FIG. 4, the flow control device 402 is fluidly coupled with a fuel input line 404 disposed upstream of the flow control device 402. The fuel input line 404 is configured to route a supply of fuel from a fuel source (not shown) to the flow control device 402 in which a flow of fuel through the fuel input line 404 may be a function of a load and speed of the gas turbine engine 100 (shown in FIG. 1).

As shown in FIG. 4, the flow control device 402 may include a first pathway 406 that is disposed in fluid communication with the upper fuel injector 114a via a first fuel output line 408. The flow control device 402 may further include a flow regulating component 410 disposed in a second pathway 412 which is in communication with the lower fuel injector 114b via a second fuel output line 414. The flow regulating component 410 is configured to be resiliently biased to a flow blocking position by a spring 416 such that when the gas turbine engine 100 operates at a low fuel flow rate such as during starting or at low-load condition, the flow blocking position of the flow regulating component 410 partially restricts a flow of fuel to the lower injector 114b.

Moreover, the flow control device 402 is configured to supply a pre-determined amount of fuel to the lower fuel injector 114b until a pressure of fuel in the fuel input line 404 exceeds a pre-determined threshold value. The partial restriction in the flow of fuel to the lower fuel injector 114b may be accomplished via an orifice 418 defined in the flow regulating component 410 for permitting a pre-determined amount of fuel to flow from the fuel input line 404 to the second pathway 412 of the flow control device 402.

The partial restriction of the flow of fuel may be accomplished using the orifice 418 of the flow regulating component 410 to advantageously correspond with the pre-determined amount of fuel required for supply to the lower fuel injector 114b such that that the lower fuel injector 114b and the upper fuel injector 114a receive a substantially uniform amount of fuel during starting or the no-load or low-load operating condition of the gas turbine engine 100. As such, the flow control device 402 is configured to advantageously supply the pre-determined amount of fuel to the lower fuel injector 114b until a pressure in the fuel input line 404 exceeds a pre-determined threshold value which corresponds with the no-load or low-load condition of the gas turbine engine 100.

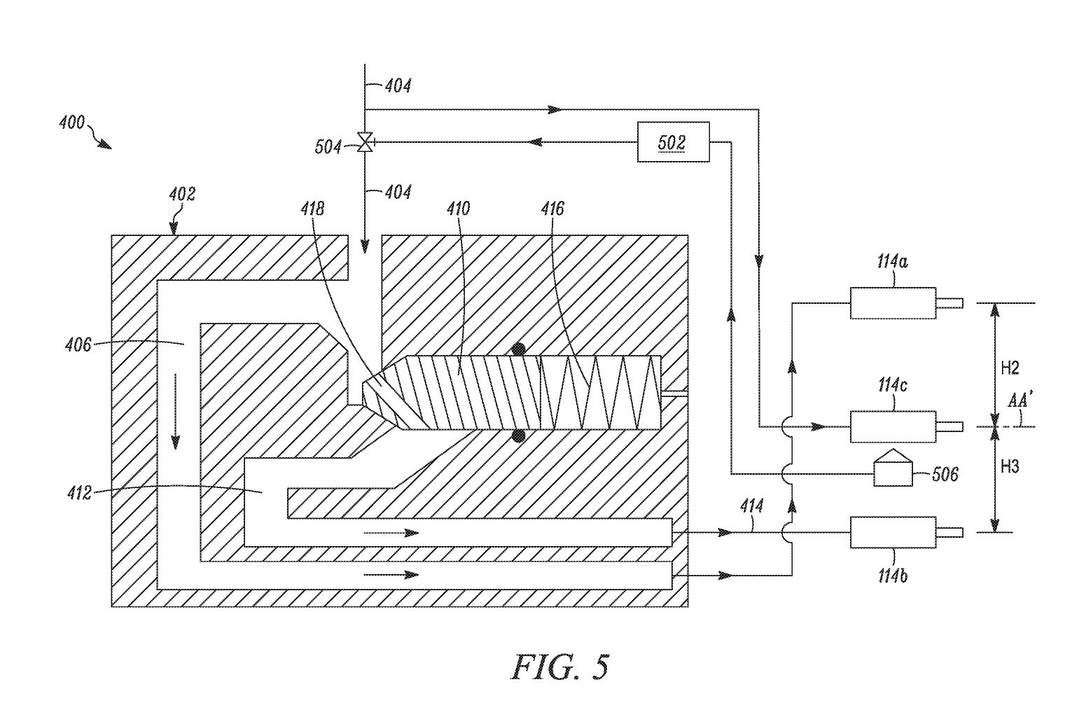

It is envisioned that upon transitioning of the operating state of the gas turbine engine 100 from the low-load condition to a full load condition, the flow regulating component 410 may move or be moved (e.g., using a controller 502 shown in FIG. 5) from the flow blocking position to a flow permitting position. Such movement of the flow regulating component 410 away from the flow blocking position into a flow permitting position is dependent on speed and load conditions of the gas turbine engine 100 to which supply of fuel in the fuel input line 404 changes for correspondingly causing the movement of the flow regulating component 410 in the flow control device 402.

In another embodiment of this disclosure, the flow control device 402 may include a controller 502 as shown in FIG. 5, the controller 502 may be operatively associated with a flow control valve 504 disposed in the fuel input line 404 and a flow sensor 506 that is configured to measure an amount of fuel being supplied to the injector 114c located substantially along the horizontal midplane AA′ (refer to FIG. 3). It is hereby envisioned that the fuel injector 114c, by virtue of being located substantially along the horizontal midplane AA′ of the combustor chamber 112, would advantageously receive an optimized amount of fuel that varies merely on the basis of the operating state of the gas turbine engine 100 i.e., speed and load conditions of the gas turbine engine 100. Based on the amount of fuel being supplied to the injector 114c, the controller 502 may modulate the flow control valve 504 for varying the inlet flow of fuel and hence, normalize the amount of fuel being supplied to the respective ones of injectors 114a and 114b via the first and second pathways 406 and 412 respectively so that each of the injectors 114a and 114b receive a uniform amount of fuel in line with that received by the injector 114c. As such, in an embodiment of this disclosure, the amount of fuel supplied to each of the injectors 114a and 114b could be a function of the height H2, H3 of the respective ones of the injectors 114a and 114b with the injector 114c shown in FIG. 5 since injector 114c is located substantially along the horizontal midplane AA′ of the combustion chamber 112.

In a further embodiment, if the flow control device 402 is an electronically operated flow control device, the controller 502 could, additionally or optionally, be disposed in operative communication with the flow regulating component 410 of the flow control device 402. This way, the controller 502 can beneficially control a movement of the flow regulating component 410 and therefore, regulate the amount of fuel being particularly supplied to the lower one of the fuel injectors 114b.

It should be noted that although the foregoing examples are discussed merely in conjunction with the injectors 114a, 114b, and 114c; it can be contemplated to execute a control in the regulation of fuel flow via the flow control device 402 to any of the injectors 114 disposed in communication with the combustion chamber 112. For example, it may be desired to regulate the amount of fuel injector 114d or 114e based on an amount of fuel supplied to either one of the upper fuel injector 114a, or the fuel injector 114c located substantially along the midplane AA′ depending on specific requirements of an application. Therefore, examples rendered in conjunction with injectors 114a, 114b, and 114c are to be construed as being non-limiting of this disclosure. Rather, embodiments of the present disclosure can be similarly applied to any of the injectors 114 for regulation of fuel to the respective ones of the injectors 114 without deviating from the spirit of the present disclosure.

Various embodiments disclosed herein are to be taken in the illustrative and explanatory sense, and should in no way be construed as limiting of the present disclosure. All joinder references (e.g., attached, affixed, associated, coupled, engaged, connected, locked, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all positional terms, such as, but not limited to, “upper”, “lower”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

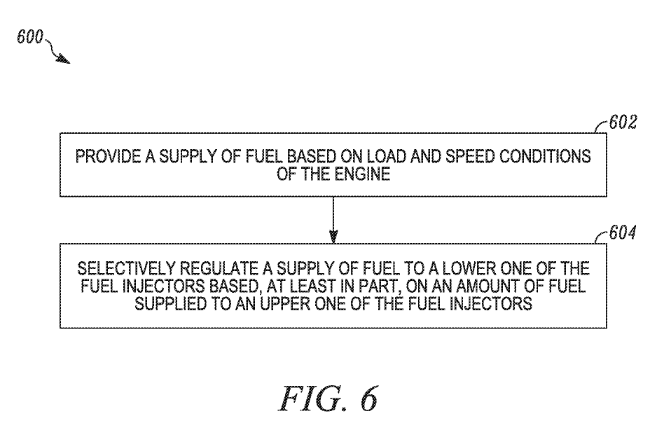

FIG. 6 illustrates a method 600 of supplying fuel to two or more injectors associated with an engine (e.g., gas turbine engine 100 as shown in FIG. 1), the injectors (e.g., the injectors 114 as shown in FIGS. 2 through 5) being positioned at heights different from one another. At step 602, the method 600 includes providing a supply of fuel based on load and speed conditions of the engine e.g., the gas turbine engine 100. At step 604, the method 600 further includes selectively regulating a supply of fuel to a lower one of the fuel injectors e.g., the lower fuel injector 114b based, at least in part, on an amount of fuel supplied to an upper one of the fuel injectors e.g., the upper injector 114a.

In an embodiment of this disclosure, the method 600 includes supplying a pre-determined amount of fuel to the lower fuel injector 114b until a supply pressure associated with the fuel exceeds a pre-determined threshold value correlating to at least an idle or low-load condition of the engine e.g., the gas turbine engine 100. Additionally, in embodiments of this disclosure, it is envisioned that the amount of fuel supplied to the lower fuel injector 114b could advantageously be implemented as a function of a difference in height between the upper and lower fuel injectors 114a and 114b for bringing about the uniform supply of fuel to each of the upper and lower injectors 114a and 114b.

Embodiments of the present disclosure have applicability for use in supplying a uniform amount of fuel to injectors of an engine in which the injectors are located at different heights relative to one another. It has been observed that an amount of fuel supplied to each of the fuel injectors for a given operating condition of the engine would typically differ due to an effect of gravity acting on the fuel being supplied to the lower positioned fuel injectors e.g., the lower fuel injector 114b shown in FIG. 3. As a result, the combustion zones associated with the lower positioned fuel injectors in the combustion chamber may receive a substantially greater amount of fuel while a remainder of the combustion zones may receive little or no fuel at all.

However, with implementation of embodiments disclosed herein, the amount of fuel supplied to the each of the injectors present on an engine can be independently regulated while taking into account the effect of gravity which, in particular, affects the lower positioned injectors in the group of injectors present on the engine. Further, with implementation of embodiments disclosed herein, each injector from the group of injectors present on a given engine can be individually configured to receive a substantially uniform amount of fuel which may altogether vary based on the operating state of the engine i.e., in relation to the speed and load condition of the engine. As a result, an optimal combustion performance can be advantageously accomplished at each combustion zone associated with the injectors present on the engine.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A fuel supply system for an engine having at least one combustion chamber, wherein the combustion chamber includes at least two combustion zones, the combustion zones being arranged at different heights from one another, the fuel supply system comprising:
at least a pair of fuel injectors corresponding to the at least two combustion zones such that at least one injector is configured to provide a supply of fuel to one combustion zone from the at least two combustion zones, wherein the pair of fuel injectors are disposed at different heights corresponding to the different heights of the combustion chambers, each of the heights being taken in reference with one of: a lower one of the fuel injectors and a horizontal midplane of the combustion chamber; and
a flow control device located upstream of the pair of fuel injectors and disposed in fluid communication with at least the lower one of the fuel injectors, the flow control device being configured to selectively regulate a supply of fuel to the lower fuel injector based, at least in part, on an amount of fuel supplied to an upper one of the fuel injectors.

2. The fuel supply system of claim 1 further comprising a fuel input line fluidly coupled to the flow control device and disposed upstream of the flow control device, the fuel input line being configured to route a supply of fuel through the flow control device.

3. The fuel supply system of claim 2, wherein the flow control device is further configured to supply a pre-determined amount of fuel to the lower fuel injector until a pressure in the fuel input line exceeds a pre-determined threshold value.

4. The fuel supply system of claim 2, wherein a flow of fuel through the fuel input line is a function of a load and speed of the engine.

5. The fuel supply system of claim 1 further comprising a first fuel output line and a second fuel output line fluidly coupled to the flow control device and disposed downstream of the flow control device, the first fuel output line being disposed in fluid communication with the upper fuel injector while the second fuel output line is disposed in fluid communication with the lower fuel injector.

6. The fuel supply system of claim 5, wherein an amount of fuel supplied to the lower fuel injector via the second fuel output line is based, at least in part, on an amount of fuel supplied to the upper fuel injector through the first fuel output line; and wherein the amount of fuel supplied to the lower fuel injector is a function of a difference in height between the upper and lower fuel injectors.

7. The fuel supply system of claim 1, wherein the flow control device includes at least one of: an electronically actuated control device and a hydraulically actuated control device.

8. An engine having at least one combustion chamber, wherein the combustion chamber includes at least two combustion zones, wherein each of the combustion zones are arranged at different heights from one another, and wherein the engine employs the fuel supply system of claim 1 to supply a substantially uniform amount of fuel to each combustion zones from the at least two combustion zones.

9. The engine of claim 8, wherein the engine is a gas turbine engine.

10. A gas turbine engine comprising:
at least one combustion chamber having at least two combustion zones, the combustion zones being configured to receive and combust fuel therein, wherein each of the combustion zones are arranged at different heights from one another;
a fuel supply system fluidly coupled to the pair of combustion zones, the fuel supply system comprising:
at least a pair of fuel injectors corresponding to the pair of combustion zones such that at least one injector is configured to provide a supply of fuel to one combustion zone from the at least two combustion zones, wherein the pair of fuel injectors are disposed at different heights corresponding to the different heights of the combustion zones, each of the heights being taken in reference with one of: a lower one of the fuel injectors and a horizontal midplane of the combustion chamber; and
a flow control device located upstream of the pair of fuel injectors and disposed in fluid communication with at least the lower one of the fuel injectors, the flow control device being configured to selectively regulate a supply of fuel to the lower fuel injector based, at least in part, on an amount of fuel supplied to an upper one of the fuel injectors.

11. The gas turbine engine of claim 10, wherein the fuel supply system further comprises a fuel input line fluidly coupled to the flow control device and disposed upstream of the flow control device, the fuel input line being configured to route a supply of fuel through the flow control device.

12. The gas turbine engine of claim 11, wherein the flow control device is further configured to supply a pre-determined amount of fuel to the lower fuel injector until a pressure in the fuel input line exceeds a pre-determined threshold value.

13. The gas turbine engine of claim 10, wherein a flow of fuel through the fuel input line is a function of a load and speed of the engine.

14. The gas turbine engine of claim 10, wherein the fuel supply system further comprises a first fuel output line and a second fuel output line fluidly coupled to the flow control device and disposed downstream of the flow control device, the first fuel output line being disposed in fluid communication with the upper fuel injector while the second fuel output line is disposed in fluid communication with the lower fuel injector.

15. The gas turbine engine of claim 14, wherein an amount of fuel supplied to the lower fuel injector via the second fuel output line is based, at least in part, on an amount of fuel supplied to the upper fuel injector through the first fuel output line; and wherein the amount of fuel supplied to the lower fuel injector is a function of a difference in height between the upper and lower fuel injectors.

16. The gas turbine engine of claim 10, wherein the flow control device includes at least one of: an electronically actuated control device and a hydraulically actuated control device.

17. A method of supplying fuel to two or more injectors associated with an engine, the injectors being positioned at heights different from one another, the method comprising:
providing a supply of fuel based on load and speed conditions of the engine; and
selectively regulating a supply of fuel to a lower one of the fuel injectors based, at least in part, on an amount of fuel supplied to an upper one of the fuel injectors.

18. The method of claim 17 further comprising supplying a pre-determined amount of fuel to the lower fuel injector until a supply pressure associated with the fuel exceeds a pre-determined threshold value correlating to at least an idle or low-load condition of the engine.

19. The method of claim 17, wherein an amount of fuel supplied to the lower fuel injector is based, at least in part, on an amount of fuel supplied to the upper fuel injector.

20. The method of claim 19, wherein the amount of fuel supplied to the lower fuel injector is a function of a difference in height between the upper and lower fuel injectors.
